(19) United States
(12) Patent Application Publication
(10) Pub. No.: US 2011/0283131 A1
(43) Pub. Date: Nov. 17, 2011

(54) Computer-readable recording medium, method, and apparatus for calculating power consumption information

(75) Inventor: Tatsuya Yamamoto, Kawasaki (JP)

(73) Assignee: FUJITSU LIMITED, Kawasaki (JP)

(21) Appl. No.: 13/067,119

(22) Filed: May 10, 2011

(30) Foreign Application Priority Data
May 14, 2010 (JP) 2010-111673

(51) Int. Cl. G06F 1/28

(52) U.S. Cl. 713/340

(57) ABSTRACT

A computer is disclosed that performs calculating power consumption information. The computer reads out, from a storage part, data indicating an execution procedure of process steps which each of function units of an integrated circuit executes, and reads out, from the storage part, a coefficient corresponding to each of the process steps. Then, the computer calculates an index value of power consumption based on the coefficient corresponding to each of the process steps included in each of unit steps into which the execution procedure is divided. The computer outputs the index value for each of the unit steps to be stored in the storage part.

### CROSS-REFERENCE TO RELATED APPLICATIONS

This patent application is based upon and claims the benefit of priority of the prior Japanese Patent Application No. 2010-111673 filed on May 14, 2010, the entire contents of which are incorporated herein by reference.

### FIELD

The embodiment discussed herein is related to a computer-readable recording medium, a method, and an apparatus for calculating information related to a power consumption of an integrated circuit.

### BACKGROUND

Conventionally, the power consumption of a system LSI (Large Scale Integration) was reduced by reducing a wiring scale. But recently, it has become difficult to further reduce the power consumption by the reduction of the wiring scale. Also, the likelihood of generating a leakage current due to the reduced wiring scale has increased.

Accordingly, recently, the power consumption is estimated by a simulation or an emulation in an implementation level such as a RTL (Register Transfer Language) description or a netlist. Based on the estimation, measures are taken to reduce the power consumption of the system LSI.

However, approximately one and a half years are required to implement the RTL description or the netlist depending on the scale of the circuit to be designed. In a case in which the power consumption is estimated after the RTL description or the netlist is implemented, and the estimated value does not fall within a tolerable range, the design workload increases due to a relatively large amount of redesigning that is required of the circuit.

### SUMMARY

According to one aspect of the embodiment, there is provided a computer-readable, non-transitory medium recorded with a program which, when executed by a computer, causes the computer to perform an index value calculating process, the process including reading out, from a storage part, data indicating an execution procedure of process steps which each of function units of an integrated circuit executes; reading out, from the storage part, a coefficient corresponding to each of the process steps; calculating an index value of power consumption based on the coefficient corresponding to each of the process steps included in each of unit steps into which the execution procedure is divided; and outputting the index value for each of the unit steps to be stored in the storage part.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating a module configuration of a system LSI which is a power consumption information calculation target in an embodiment;

FIG. 2 is a diagram for generally explaining a power consumption information calculation method in the embodiment;

FIG. 3 is a diagram illustrating a hardware configuration example of a power consumption information calculating apparatus in the embodiment;

FIG. 4 is a diagram illustrating a functional configuration example of the power consumption information calculating apparatus in the embodiment;

FIG. 5 is a flowchart for explaining a process sequence of a coefficient calculation process based on specification data;

FIG. 6 is a diagram illustrating a description example of the specification data in the embodiment;

FIG. 7 is a diagram illustrating a configuration example of a coefficient storing part;

FIG. 8 is a flowchart for explaining a process sequence of a time-sequential power consumption index value calculation process;

FIG. 9 is a diagram illustrating a configuration example of a time-sequential index value storing part;

FIG. 10 is a flowchart for explaining a process sequence of a module power consumption index value calculation process;

FIG. 11 is a diagram illustrating a configuration example of a module index value storing part;

FIG. 12 is a diagram for explaining a knowledge example acquired from the time-sequential index value;

FIG. 13A through FIG. 13D are diagrams illustrating knowledge examples acquired by comparing the time-sequential index value with an actually measured amount of the power consumption; and

FIG. 14 is a diagram for explaining a calculation of the power consumption index value related to a function module when the function module is segmented.

### DESCRIPTION OF EMBODIMENTS

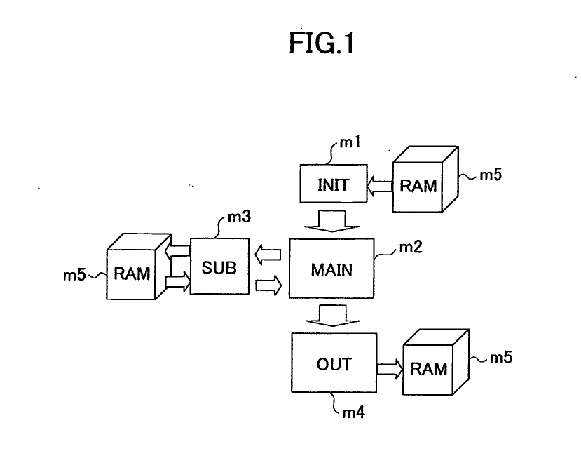

In the following, an embodiment of the present invention will be described with reference to the accompanying drawings. In the embodiment, a system LSI (Large Scale Integration) including modules (function units) illustrated in FIG. 1 is a calculation subject of power consumption information.

FIG. 1 is a diagram illustrating a module configuration of a system LSI which is a power consumption information calculation target in the embodiment. FIG. 1 illustrates an INIT module m1, a MAIN module m2, a SUB module m3, an OUT module m4, and RAM (Random Access Memory) modules m5 as an example of a memory. These modules m1 through m5 may be implemented to be all modules in one system LSI or modules in a part of the system LSI. In FIG. 1, arrows illustrate transactions among the modules m1 through m5. In the embodiment, contents of functions of the modules m1 through m5 are not objectives. Also, entities of the modules m1 through m5 depend on an abstraction level of a circuit. For example, if the modules m1 through m5 are TLM (Transaction Level Modeling) describing the circuit in a programming language, each of the modules m1 through m5 corresponds to one function.

Moreover, the system LSI in the embodiment is the same as a generally known system LSI, and is an LSI including a circuit which includes a CPU (Central Processing Unit) and a specific function, an LSI in which only a specific function such as media processing or the like is implemented and a CPU may not be implemented, or the like. Moreover, power consumption information is information concerning power consumption, and is not always limited to an amount of the power consumption as described later.

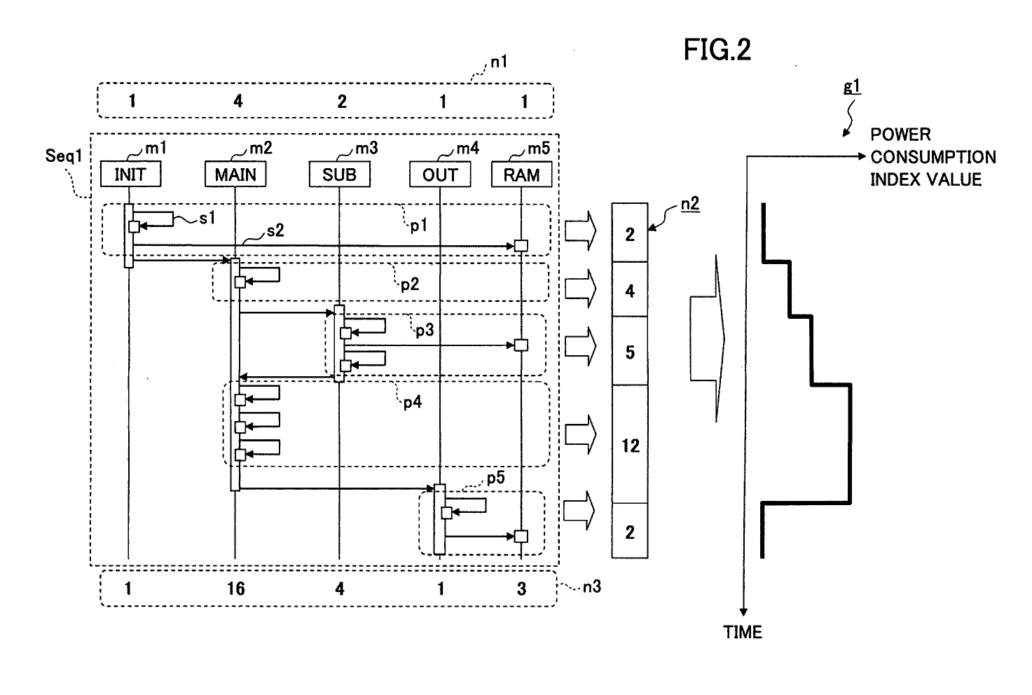

In the embodiment, the power consumption information related to a system LSI having the module configuration as illustrated in FIG. 1 is calculated as illustrated in FIG. 2.

FIG. 2 is a diagram for generally explaining a power consumption information calculation method in the embodiment.

In the embodiment, when the power consumption information of the system LSI is calculated, information, which indicates an execution procedure (a process sequence) of process steps (operation steps) of each of the modules (function units) m1 through m5, is regarded as input information. In the embodiment, a sequence diagram of UML (Unified Modeling Language) is used as the information indicating the execution procedure. In FIG. 2, a sequence diagram Seq1 is illustrated. The sequence diagram Seq1 illustrates the process sequence (or an operation sequence) with respect to an operational scenario concerning each of the modules m1 through m5 illustrated in FIG. 1.

First, a weighting coefficient (hereinafter, simply called “coefficient”) for the power consumption information is assigned to each of the modules ml through m5. In FIG. 2, respective values of the coefficient n1 are illustrated above the modules m1 through m5. In this case, the coefficients n1 of 1, 4, 2, 1, and 1 are applied respectively to the INIT module m1, the MAIN module m2, the SUB module m3, the OUT module m4, and the RAM modules m5.

Next, a power consumption index value of a time-sequence (for each term) is calculated based on process steps conducted in a unit (or a term) and a coefficient of a module which conducted the process steps for each unit (or for each term). The unit (or the term) is made by segmenting a series of the process sequence (the execution procedure) from the start of a first step to the end of a last step in the sequence diagram Seq1 by a predetermined rule. In FIG. 2, as a calculation example, power consumption index values n2 are illustrated with values 2, 4, 5, 12, and 2 in terms p1, p2, p3, p4, and p5, respectively. Also, a graph g1 is a graph depicting the power consumption index values n2 in the time-sequence.

Next, for each of the modules m1 through m5 (that is, in a vertical axis direction of the sequence diagram Seq1 in FIG. 2), a module power consumption index value is calculated based on the process steps conducted by the module and the value of the coefficient of the module. In FIG. 2, as a calculation example, module power consumption index values n3 are illustrated with values 1, 16, 4, 1, and 3, respectively to the INIT module m1, the MAIN module m2, the SUB module m3, the OUT module m4, and the RAM modules m5.

The power consumption index values in the time-sequence, and the module power consumption index values are the power consumption information in the embodiment. It should be noted that the power consumption index values are relative values based on the coefficients. In the embodiment, for the sake of convenience, an implementation level of the circuit of the system LSI is the TLM.

In the following, a power consumption information calculating apparatus 10, which calculates the power consumption information, will be described.

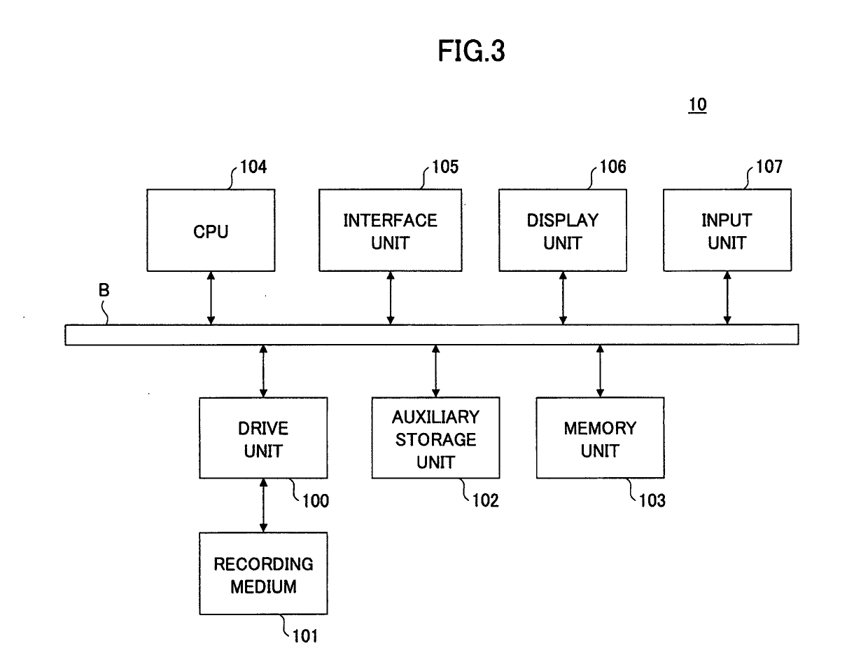

FIG. 3 is a diagram illustrating a hardware configuration example of a power consumption information calculating apparatus in the embodiment. In FIG. 3, the power consumption information calculating apparatus 10 includes a drive unit 100, an auxiliary storage unit 102, a memory unit 103, a processor such as a CPU 104, an interface unit 105, a display unit 106, and an input unit 107.

A program realizing a process, which is executed by the power consumption information calculating apparatus 10, is provided by a recording medium 101 such as a CD-ROM (Compact Disk Read Only Memory) or the like. For example, the recording medium 101 may be formed by a non-transitory (or tangible) computer-readable recording medium. When the recording medium 101 storing the program is set in the drive unit 100, the program is installed into the auxiliary storage unit 102 through the drive unit 100 from the recording medium 101. However, it is not always required to install the program from the recording medium 101. The program may be downloaded from another computer through a network. The auxiliary storage unit 102 stores necessary files, data, and the like as well as the program.

The recording medium 101, the auxiliary storage unit 102, and the memory unit 103 may form a storage part.

When the CPU 104 is instructed to execute the program, the program is read from the auxiliary storage unit 102 and stored in the memory unit 103. The CPU 104 realizes a function of the power consumption information calculating apparatus 10 in accordance with the program stored in the memory unit 103. The interface unit 105 provides an interface to connect the power consumption information calculating apparatus 10 to the network. The display unit 106 displays a GUI (Graphical User Interface) by the program, and the like. The input unit 107 may include a keyboard, a mouse, and the like, and may be used to input various operation instructions.

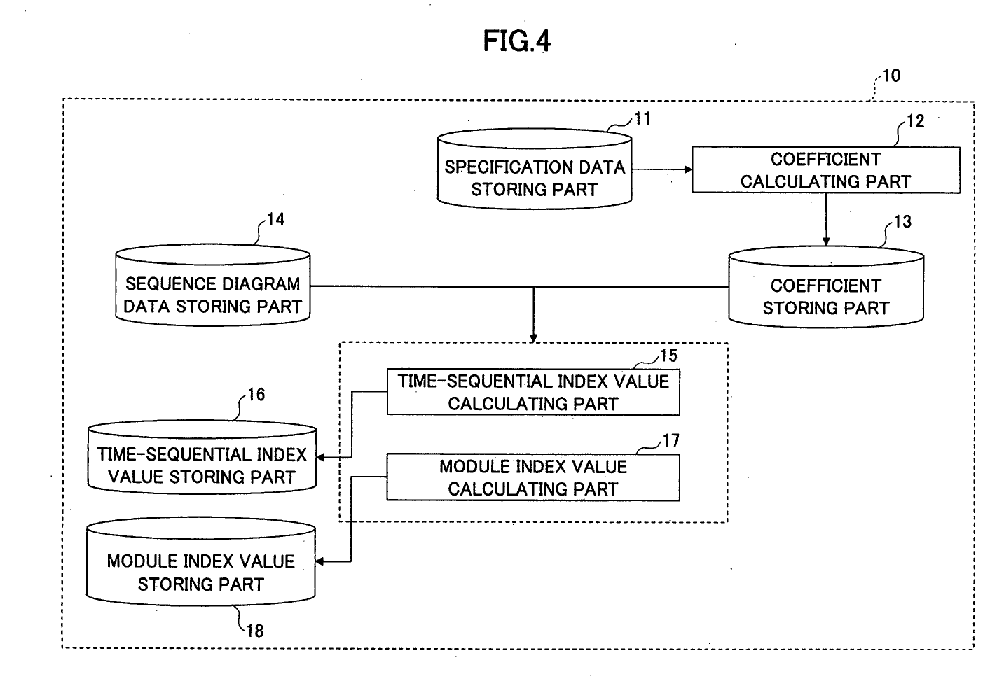

FIG. 4 is a diagram illustrating a functional configuration example of the power consumption information calculating apparatus in the embodiment. In FIG. 4, the power consumption information calculating apparatus 10 includes a specification data storing part 11, a coefficient calculating part 12, a coefficient storing part 13, a sequence diagram data storing part 14, a time-sequential index value calculating part 15, a time-sequential index value storing part 16, a module index value calculating part 17, a module index value storing part 18, and the like. These parts 11 through 18 may be realized by processes performed by the CPU 103 which executes the program installed in the auxiliary storage unit 102 of the power consumption information calculating apparatus 10. In this example, the calculating parts 12, 15, 17, and the like may be formed by the CPU 104.

The specification data storing part 11 may form a storage area to store specification data in the auxiliary storage unit 102. The specification data are electronic data of a specification in which a functional specification is written for each module in a natural language. The coefficient calculating part 12 calculates the coefficient for each module by using the specification data. The coefficient storing part 13 may form a storage area to store the coefficient calculated by the coefficient calculating part 12 in the auxiliary storage unit 102 by associating with the module. The sequence diagram data storing part 14 may form a storage area to store data indicating the sequence diagram Seq1 (hereinafter, called “sequence diagram data”.) in the auxiliary storage unit 102.

The time-sequential index value calculating part 15 calculates the power consumption index value of the time-sequence based on the sequence diagram data stored in the sequence diagram data storing part 14 and the coefficients stored in the coefficient storing part 13. The time-sequential index value storing part 16 may form a storage area to store the power consumption index value calculated by the time-sequential index value calculating part 15 in the auxiliary storage unit 102. The module index value calculating part 17 calculates the module power consumption index value for each module based on the sequence diagram data stored in the sequence diagram data storing part 14 and the coefficients stored in the coefficient storing part 13. The module index value storing part 18 may form a storage area to store the power consumption index value for each module calculated by the module index value calculating part 17 in the auxiliary storage unit 102. In this example, the storing parts 11, 13, 14, 16, and 18 are formed by the auxiliary storage unit 102, however, these storing parts 11, 13, 14, 16, and 18 may be formed by the storage part including one or more storage units.

In the following, the process sequence of the power consumption information calculating apparatus 10 will be described.

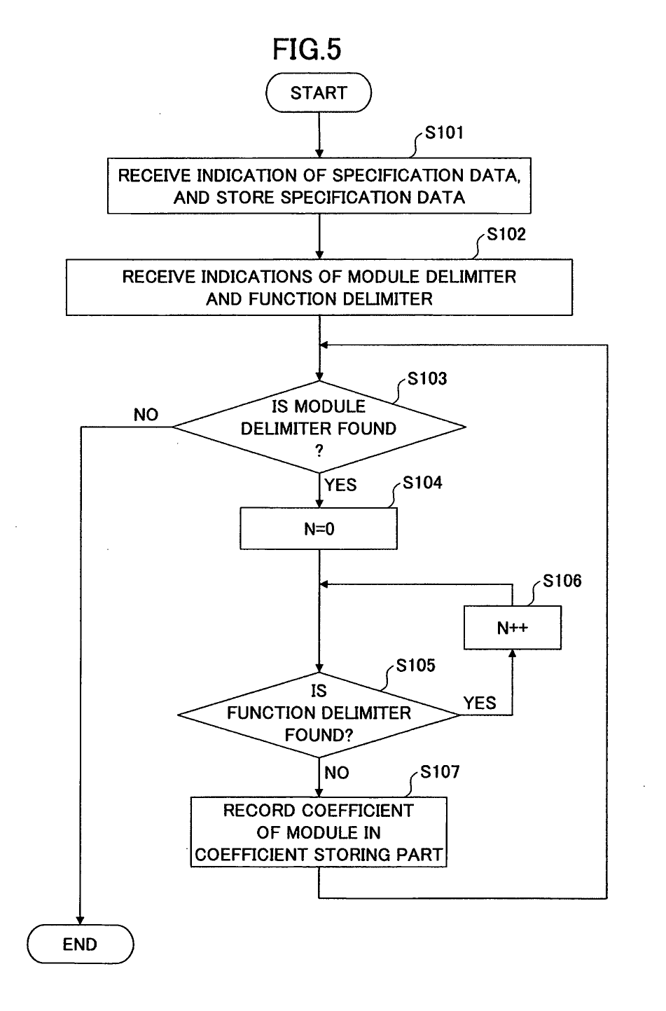

FIG. 5 is a flowchart for explaining a process sequence of a coefficient calculation process based on specification data.

In step S101, the coefficient calculating part 12 receives an indication of the specification data from a user, and stores the specification data indicated by the user in the memory unit 103. For example, the indication of the specification data is conducted by indicating a file name of a file in which the specification data are stored.

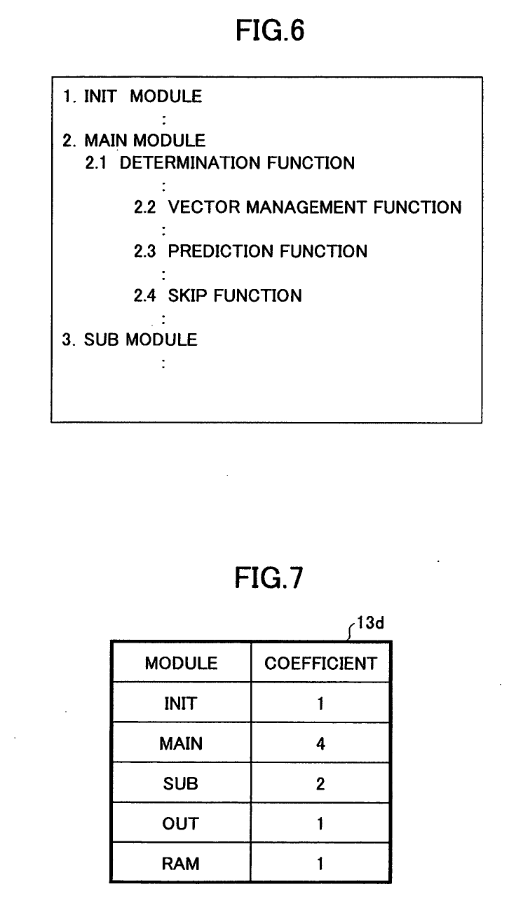

FIG. 6 is a diagram illustrating a description example of the specification data in the embodiment. In FIG. 6, in a format of “N.<module name>”, a title of an explanation concerning the module name is described. Also, in a format of “N.M <function name>”, a title of an explanation is described for each function included in the module.

Next, the coefficient calculating part 12 receives an indication of a mark (hereafter, called “module delimiter”) to identify a segment (for example, a title) of a description for each module, and a mark (hereinafter, called “function delimiter”) to identify the segment (for example, the title) of a description for each function in the module, in the specification data from the user (S102). For example, in a case of the specification data in FIG. 6, “N.” is indicated by the module delimiter. Also, “N.M” is indicated by the function delimiter.

Next, the coefficient calculating part 12 searches for the module delimiter from a beginning (a first line of a first page) of the specification data (step S103). When the module delimiter is found, the coefficient calculating part 12 initializes a variable N to zero to store the coefficient (step S104). Next, the coefficient calculating part 12 searches for the function delimiter from a location where the module delimiter is found (step S105), and increments the variable N by one every time the function delimiter is found (step S106). That is, in the embodiment, the number of functions of the module is a value of the coefficient. Since the more the number of functions the more power the module consumes, it may be regarded that a correlation exists between the number of functions and the power consumption. In a case in which the function delimiter is not found, the coefficient calculating part 12 records a value of the variable N as the coefficient by associating it with the module name of the module which is a current subject to process (step S107). A case in which the function delimiter is not found includes a case in which the module delimiter of a next module is found, a case in which an end of the specification data is found, or the like.

After that, the steps S103 through 107 are repeated until the module delimiter is not found. As a result, for example, the coefficient storing part 13 stores data 13d as illustrated in FIG. 7.

FIG. 7 is a diagram illustrating a configuration example of the coefficient storing part 13. In FIG. 7, the data 13d are recorded in the coefficient storing part 13 and indicate similar to the values of the coefficients n1 in FIG. 2. It should be noted that a default value “1” may be recorded for the RAM modules m5.

As described above, for a calculation of the coefficient based on the specification data, it is preferable to create the specification data to be a structural document in such as XML (extensible Markup Language), SGML (Standard Generalized Mark-up Language), or the like. For example, if the specification data are XML data, the module delimiter and the function delimiter may be indicated by respective tag names.

Also, instead of counting the functions, the number of lines in the description concerning the module may be counted, since it may be regarded that a correlation exists between a quantity of functions and an amount of the explanation.

Moreover, the coefficient may be given by the user, instead of being automatically calculated. In this case, the user may determine a weight, a size, or the like of the functions of each module, and may apply the coefficient to the corresponding module based on a determination result. The value of the coefficient may be a relative value between the modules. Thus, if a relative relationship between the modules becomes apparent, the value of the coefficient may be counted in any manner.

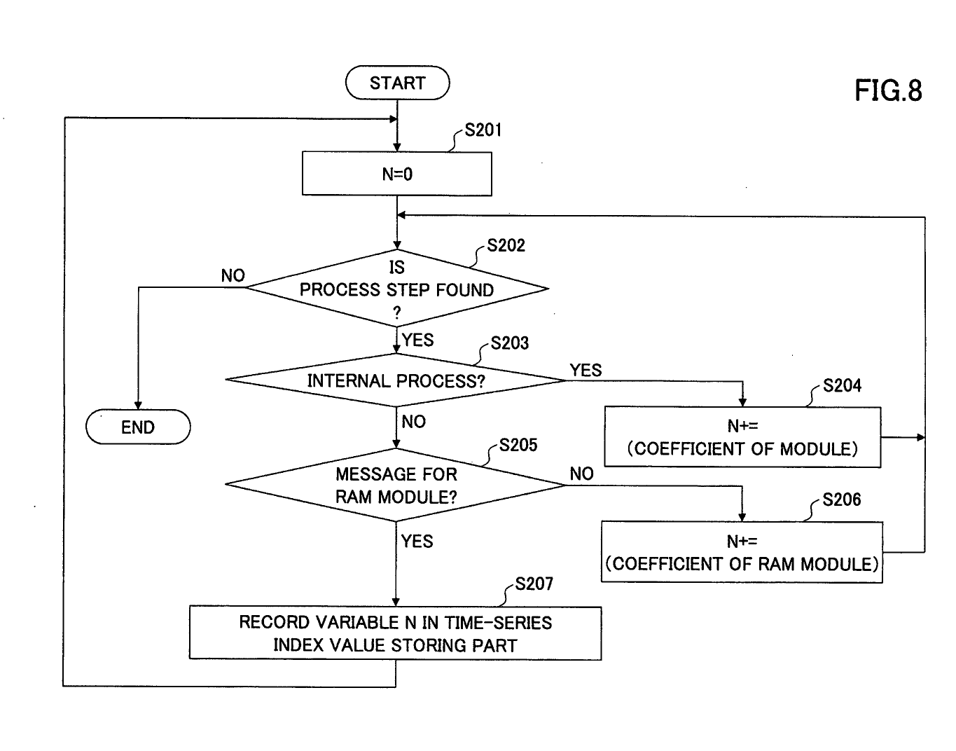

Next, a calculation process of the power consumption index value in the time-sequence will be described. FIG. 8 is a flowchart for explaining a process sequence of a time-sequential power consumption index value calculation process.

In step S201, the time-sequential index value calculating part 15 initializes a variable N to zero to store the power consumption index value in the time-sequence (hereinafter, called “time-sequential index value”). Next, the time-sequential index value calculating part 15 searches for one process step in the time-sequence from the sequence diagram data of the sequence diagram Seq1 (step S202). When the process step is found, the time-sequential index value calculating part 15 determines whether or not the process step is an internal process (step S203). The internal process is a process executed inside the module such as a step s1 of the sequence diagram Seq1 in FIG. 2.

When the process step is the internal process (Yes in the step S203), the time-sequential index value calculating part 15 acquires the coefficient with respect to the module which is an execution subject of the process step, from the coefficient storing part 13, and adds the coefficient to the variable N (step S204). After that, the step S202 and the following steps are repeated.

On the other hand, when the process step is not the internal process (No in the step S203), the time-sequential index value calculating part 15 determines whether or not the process step is a message to a RAM module (step S205). The message calls another module such as a step s2 of the sequence diagram Seq1 in FIG. 2.

When the process step is the message to the RAM module (Yes in the step S205), the time-sequential index value calculating part 15 acquires the coefficient with respect to the RAM module from the coefficient storing part 13, and adds the coefficient to the variable N (step S206). Then, the step S202 and the following steps are repeated.

On the other hand, when the process step is not the message to the RAM module (No in the step S205), it is determined that the process message is a message for another module other than the RAM module. The message for another module is to switch the execution subject of a process. Accordingly, in this case, the coefficient calculating part 12 determines the process step to be a delimiter of a calculation term of the power consumption index value in the time-sequence, and records a current value of the variable N as the time-sequential index value for the calculation term in the time-sequential index value storing part 16 (step S207). That is, in the embodiment, a timing to switch the execution subject of the process is determined as the delimiter of a term in which the coefficient is additionally recorded with the power consumption in the time-sequence. The term related to the power consumption index value in the time-sequence, in which a process is consecutively conducted by the same module, is considered proper as the delimiter.

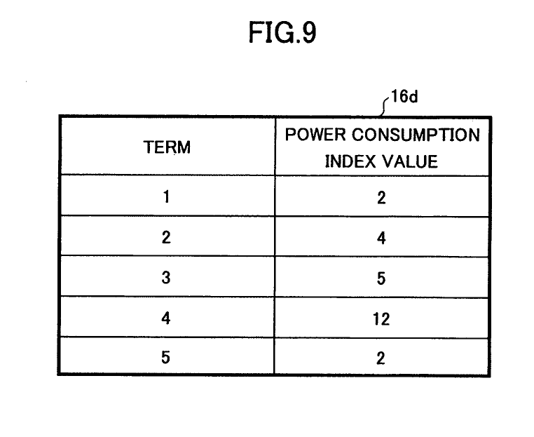

After that, the step S201 and the following steps are conducted until the process step is not found (that is, until an end of the sequence diagram Seq1). As a result, for example, the time-sequential index value storing part 16 stores data 16d as illustrated in FIG. 9.

FIG. 9 is a diagram illustrating a configuration example of the time-sequential index value storing part 16. As illustrated in FIG. 9, the time-sequential index value storing part 16 stores the data 16d in which the power consumption index value is recorded for each of terms divided in the time-sequence. Power consumption index values recorded in the data 16d illustrated in FIG. 9 are the same as the power consumption index values n2 illustrated in FIG. 2.

In general, a user is a designer of a circuit, and comprehends an operation of the circuit. Thus, the delimiter of the execution procedure may be arbitrarily indicated by the user. The user may indicate more than one process step (hereinafter, called “delimiter step”.) which sections between terms, when calculating the power consumption index value in FIG. 8. In FIG. 8, until the delimiter step is found in the step S202, the steps S203 through S206 are repeated. When the delimiter step is found, the step S207 may be conducted.

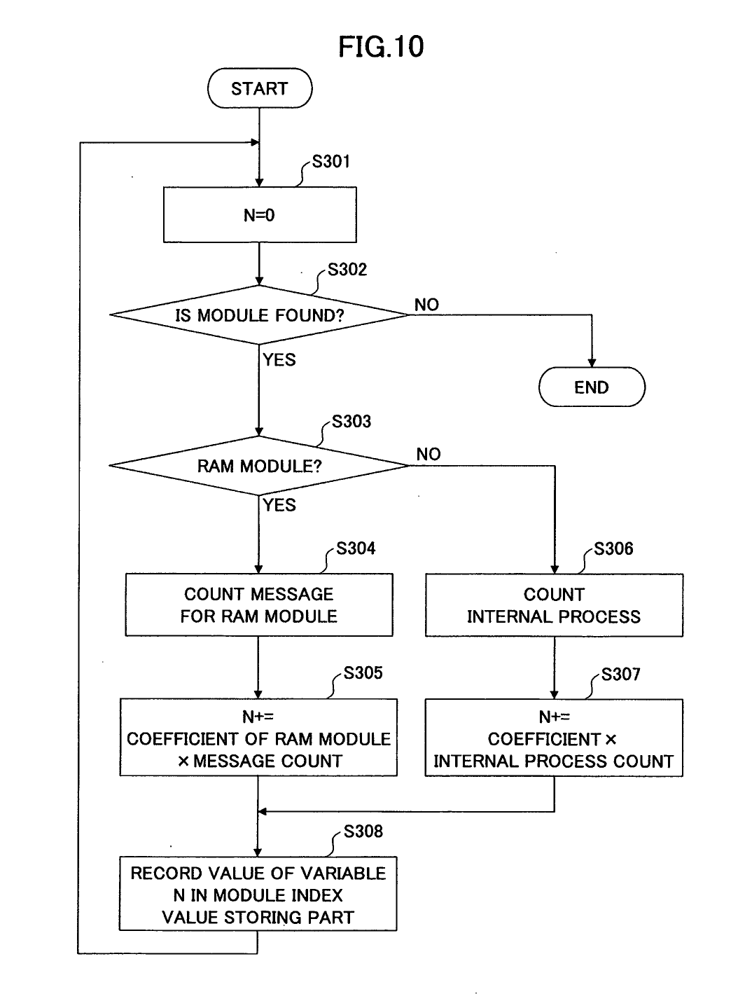

Next, a calculation process of the module power consumption index value will be described. FIG. 10 is a flowchart for explaining a process sequence of a module power consumption index value calculation process.

In step S301, the module index value calculating part 17 initializes a variable N to zero to store the module power consumption index value (hereinafter, called “module index value”). Next, the module index value calculating part 17 searches for one module (in a vertical axis direction of the sequence diagram Seq1 in FIG. 2) from the sequence diagram data of the sequence diagram Seq1 in FIG. 2 (step S302). Then, the module index value calculating part 17 determines whether or not a RAM module is found (step S303). It is determined based on the module name whether or not the found module is the RAM module.

When the module is the RAM module (Yes in the step S303), the module index value calculating part 17 searches for a message for the module from the sequence diagram data (step S304). For example, referring to the sequence diagram Seq1 in FIG. 2, three messages are counted. Next, the module index value calculating part 17 acquires the coefficient of the RAM module from the coefficient storing part 13, adds a value to the variable N, the value being acquired by multiplying a message count for the RAM module with the coefficient (step S305). Then, the module index value calculating part 17 records a value of the variable N as the module index value for the RAM module in the module index value storing part 18 (step S308).

On the other hand, when the module is not the RAM module (No in the step S303), the module index value calculating part 17 searches for an internal process of the module from the sequence diagram data, and counts the internal process when the internal process is found (step S306). For example, in the sequence diagram Seq1 illustrated in FIG. 2, the internal process count is 1 in the INIT module m1. Next, the module index value calculating part 17 acquires the coefficient for the module from the coefficient storing part 13, and adds a value to the variable N, the value being acquired by multiplying a message count for the RAM module with the coefficient (step S307). Thus, the module index value calculating part 17 records the value of the variable N as the module index value for the module in the module index value storing part 18 (step S308).

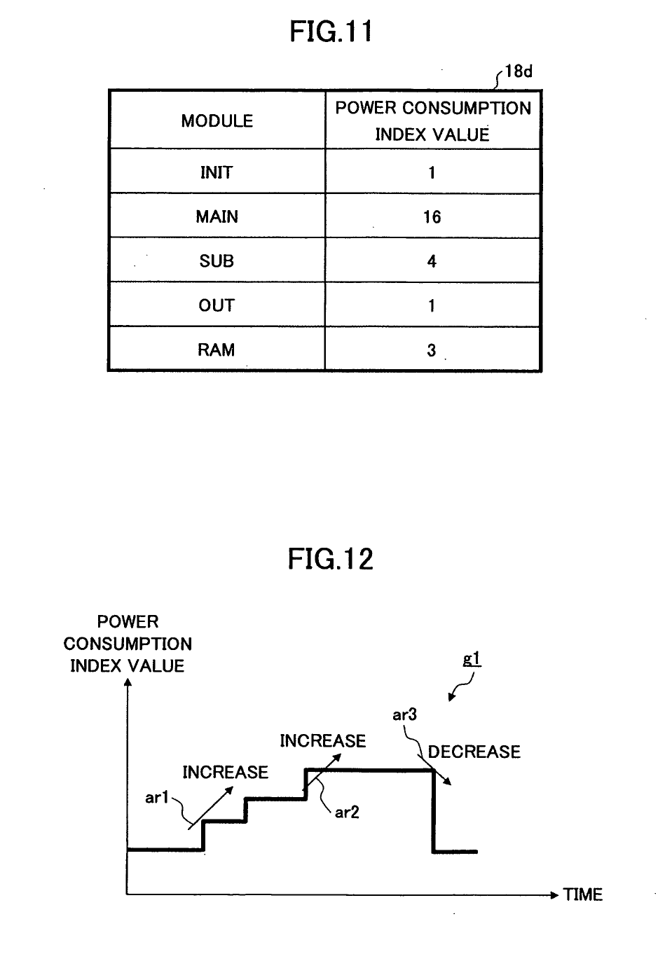

After that, the step S301 and the following steps are repeated until the module is not found. As a result, for example, the module index value storing part 18 stores data 18d as illustrated in FIG. 11.

FIG. 11 is a diagram illustrating a configuration example of the module index value storing part. As illustrated in FIG. 11, the power consumption index value is recorded for each module in the time-sequential index value storing part 16. Power consumption index values recorded in the data 18d illustrated in FIG. 11 are the same as the module power consumption index values n3 illustrated in FIG. 2.

Based on the power consumption index value calculated as described above, for example, the user can acquire knowledge as follows.

FIG. 12 is a diagram for explaining a knowledge example acquired from the time-sequential index value. In FIG. 12, the graph g1 in FIG. 2 is depicted in which a time axis is positioned to be a horizontal axis. As illustrated by arrows a1, a2, and a3, according to the time-sequential index values, in a board view, it is possible to presume or predict a change tendency of a power consumption amount. Referring to FIG. 12, it is possible for the user to comprehend that the power consumption index value is increased at first, and after that, is decreased.

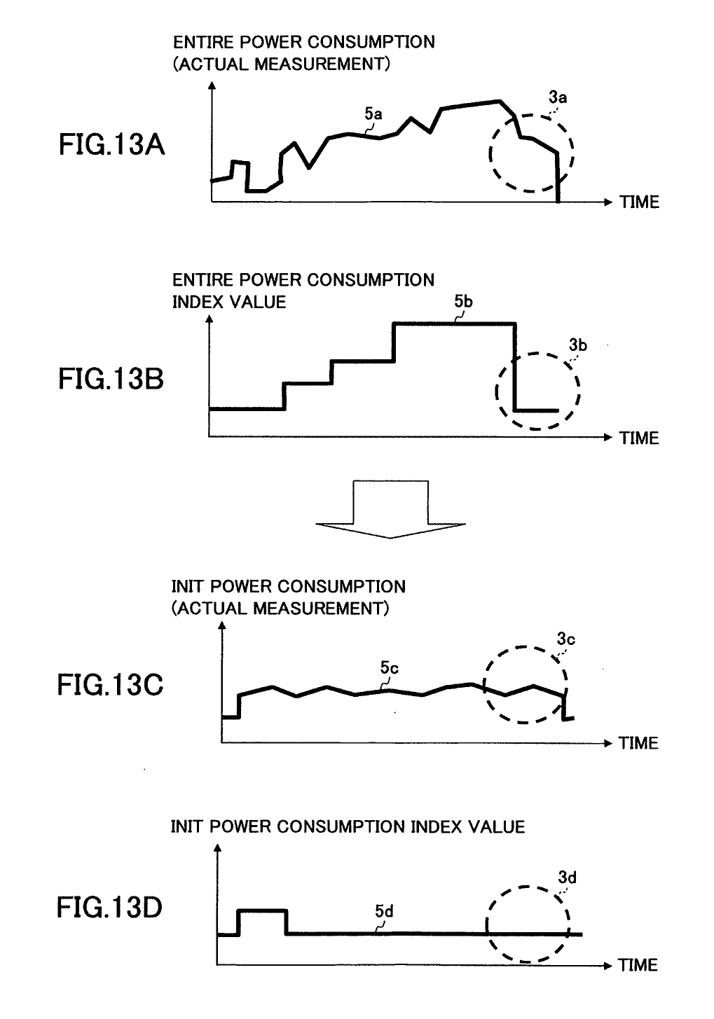

Also, FIG. 13A through FIG. 13D are diagrams illustrating knowledge examples acquired by comparing the time-sequential index value with an actually measured amount of the power consumption.

FIG. 13A illustrates a waveform 5a of the actually measured amount of the power consumption of the entire system LSI. FIG. 13B illustrates the graph g1 in FIG. 12. That is, a waveform 5b of the time-sequential power consumption index value of the entire system LSI is illustrated by the graph g1. In a case of comparing the waveform 5a in FIG. 13A with the waveform 5b in FIG. 13B, the power consumption index value in a portion 3b (term) surrounded by dashed line is decreased in the waveform 5b in FIG. 13B. On the contrary, the power consumption in a portion 3a (term) surrounded by dashed line indicates a relatively high level in the waveform 5a in FIG. 13A. As described above, in a case in which there is a significant difference between the portions 3a and 3b, for example, the actually measured amount and the time-sequential index value are compared for each module. FIG. 13C and FIG. 13D illustrate a comparison example in a case of the INIT module m1. That is, FIG. 13C illustrates a waveform 5c of an actually measured amount of the power consumption concerning the INIT module ml. Also, FIG. 13D illustrates a waveform 5d of the time-sequential index value concerning the INIT module m1. In a case of comparing both the waveforms 5c and 5d, it is recognized that power is consumed for an initial period of time in the waveform 5d and the power stays at a low level in a portion (term) 3d in FIG. 13D. On the contrary, in the waveform 5c in FIG. 13C, it is recognized that the power is successively consumed even in a portion (term) 3c in which the INIT module ml does not function under a normal circumstance. Accordingly, it is possible to indicate a possibility of a problem with a power control such as a clock gating for the INIT module m1.

Also, it is possible to comprehend a relative relationship of the power consumption between the modules based on the module index value. A designer of a circuit is greatly interested in which module the power consumption may be greater. Accordingly, it is significantly useful for the designer to comprehend the relative relationship of the power consumption between the modules.

For example, in a case in which the design is advanced and the MAIN module m2 in the embodiment is segmented, the time-sequential index value and the module index value may be calculated for a module group included in the MAIN module m2.

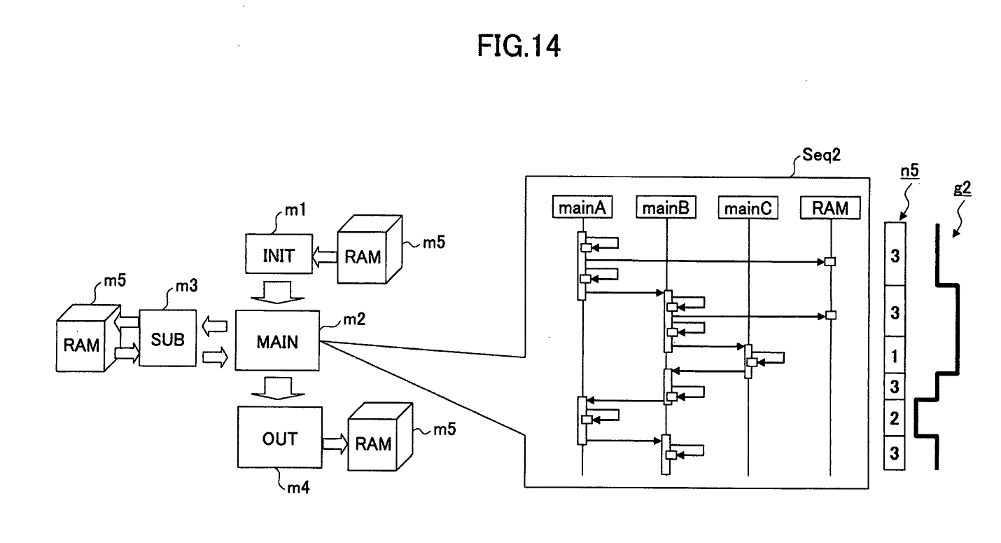

FIG. 14 is a diagram for explaining a calculation of the power consumption index value related to a function module when the function module is segmented. In FIG. 14, a sequence diagram Seq2, a time-sequential index value n5, and a graph g2 of a time-sequential index value n5 are illustrated in a case in which the MAIN module m2 is segmented into modules mainA, mainB, and mainC. As described above, depending on a segment of the function module, the embodiment may be applied to a part of the function module.

As described above, according to the embodiment, if data (for example, data indicating a sequence diagram) are defined in which the data indicate an execution order of the process steps conducted by each of modules (by a function unit) of a semiconductor integrated circuit such as the system LSI or the like, and also indicate a call step between the modules, the power consumption index value can be acquired. If a transaction between the modules such as in the TLM is clearly described in a step, the embodiment can be applied. Accordingly, in an upstream of an implementation step of the circuit, it is possible to provide useful information concerning the power consumption.

In addition, the embodiment can be applied to implementations other than the TLM, such as the RTL description, the netlist, or the like. In a case in which the embodiment is applied to such other implementations, a substance, to which the module is applied, is changed based on an implementation to be a subject to apply. In a case of the RTL description, the netlist, or the like, a further specific or physical circuit element may be applied to the module.

In the embodiment, a function count for each module is applied to be the coefficient for the corresponding module. The function count is a numeral value concerning all process steps which the module executes. For example, referring to FIG. 14, the MAIN module m2 includes four internal processes. A value “4” corresponds to the number of internal processes. In this case, it is considered that as described above in the embodiment, in a case in which the coefficient of the module is added for each of the process steps for each module, the power consumption index value may be overestimated. In the embodiment, in order to significantly comprehend a difference between the function counts, it is possible to increment the coefficient every process step.

Alternatively, the coefficient may be applied for each module and each process step. That is, based on a process weight or the like applied to the process step, the coefficient is defined for each of the process steps. In this case, even if there are multiple process steps in the same module, the coefficient to be added can be different depending on each of the multiple process steps.

It may be regarded that the coefficient is applied for each process step. That is, in the embodiment, it may be regarded that the coefficient for each process step is applied (shared) by the module unit. As described in the embodiment, in a manner of applying the coefficient by the module unit, advantageously, it is possible to reduce workload applying the coefficient.

According to the embodiment, in an upstream step in a higher abstraction level of a circuit above the design step of the RTL, the netlist, or the like, useful information concerning the power consumption can be provided. Therefore, it is possible to reduce the likelihood of an occurrence of a re-design when an abstraction level of the circuit becomes lower.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable, non-transitory medium recorded with a program which, when executed by a computer, causes the computer to perform an index value calculating process, the process comprising:
reading out, from a storage part, data indicating an execution procedure of process steps which each of function units of an integrated circuit executes;
reading out, from the storage part, a coefficient corresponding to each of the process steps;
calculating an index value of power consumption based on the coefficient corresponding to each of the process steps included in each of unit steps into which the execution procedure is divided; and
outputting the index value for each of the unit steps to be stored in the storage part.

2. The medium as claimed in claim 1, wherein the data includes a call step between the function units, and the execution procedure is divided into the unit steps by the call step as a delimiter when the calculating calculates the index value.

3. The medium as claimed in claim 1, the process further comprising:
calculating the index value based on the coefficient corresponding to each of the process steps which the function unit executes, for each of the function units based on the data, and
outputting the index value for each of the function units to be stored in the storage part.

4. The medium as claimed in claim 1, wherein the coefficient is shared with the process steps executed in a module.

5. A method for calculating an index value of power consumption regarding an integrated circuit, the calculation method comprising:
reading out, from a storage unit, data indicating an execution procedure of process steps which each of function units of the integrated circuit executes;
reading out, from the storage unit, a coefficient corresponding to each of the process steps;
calculating, by a computer, an index value of power consumption based on the coefficient corresponding to each of the process steps included in each of unit steps into which the execution procedure is divided; and
outputting the index value for each of the unit steps to be stored in the storage unit.

6. The method as claimed in claim 5, wherein the data includes a call step between the function units, and the execution procedure is divided into the unit steps by the call step as a delimiter when the calculating calculates the index value.

7. The method as claimed in claim 5, the method further comprising:
calculating, by the computer, the index value based on the coefficient corresponding to each of the process steps which the function unit executes, for each of the function units based on the data, and
outputting, by the computer, the index value for each of the function units to be stored in the storage part.

8. The method as claimed in claim 5, wherein the coefficient is shared with the process steps executed in a module.

9. A calculating apparatus for an index value of power consumption regarding an integrated circuit, the calculating apparatus comprising:
a memory configured to store data indicating an execution procedure of process steps which each of function units of an integrated circuit executes, and a coefficient corresponding to each of the process steps; and
a processor configured to execute a procedure, the procedure comprising:
calculating an index value of power consumption based on the coefficient corresponding to each of the process steps included in each of unit steps into which the execution procedure is divided, and to output the index value for each of the unit steps to be stored in the memory.

10. The calculating apparatus as claimed in claim 9,
wherein the data includes a call step between the function units, and
wherein the calculating divides the execution procedure into the unit steps by the call step as a delimiter.

11. The calculating apparatus as claimed in claim 9, the processor configured to execute the procedure, the procedure further comprising:
calculating the index value based on the coefficient corresponding to each of the process steps which the function unit executes, for each of the function units based on the data, and to output the index value for each of the function units to be stored in the memory.

12. The calculating apparatus as claimed in claim 9, wherein the coefficient is shared with the process steps executed in a module.
